(19) United States
(12) Patent Application Publication
(10) Pub. No.: US 2009/0278910 A1
(43) Pub. Date: Nov. 12, 2009

(54) Pattern Forming Method, Pattern Forming Apparatus, Method for Manufacturing a Recording Medium and Method of Manufacturing Patterned Member

(75) Inventor: Naohisa Matsushita, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kanagawa (JP)

(21) Appl. No.: 12/117,593

(22) Filed: May 8, 2008

(51) Int. Cl. B41J 2/45; H01S 3/10

(52) U.S. Cl. 347/238; 372/25

(57) ABSTRACT

In order to realize a pattern forming method for more precisely controlling a reacting area of photosensitive resin during formation of a fine pattern on a substrate and also for simplifying thickness management of the photosensitive resin a fine pattern can be formed through reaction of the photosensitive resin layer by particularly condensing an ultra-short pulse laser to a location where the focal point of the laser is at the interface between the substrate and the photosensitive resin. In this case, the ultra-short pulse laser is radiated through the substrate.

### CROSS-REFERENCE TO RELATED APPLICATIONS

This application is based upon and claims the benefit of priority from the prior Japanese Patent Application No. 2006-245281, filed on Sep. 11, 2006, the entire content of which is incorporated herein by reference.

### BACKGROUND OF THE INVENTION

The present invention relates to a method for forming a fine pattern on a substrate and more specifically to a manufacturing method of substrate having a fine pattern thereon.

In recent years, there are requests to form a fine pattern on various substrates in various fields. As such, forming much narrower, and finer patterns is necessary to meet the demand.

To form a fine pattern on a substrate, a glass mask where a required pattern is formed is used. Such a glass mask is set on a substrate coated with photosensitive resin, and the photosensitive resin on the substrate is exposed and developed through irradiation of the light beam from the upper side of the glass mask. As a result, a pattern identical to that formed on the glass mask is formed on the substrate.

However, in such a pattern forming method, only the pattern having a size the same as the mask size can be formed, because of a restriction on pattern formation. Moreover, in the pattern formation method using a glass mask, the pattern which may be formed on the substrate has been restricted in its minimum width to about 1 μm. However, in recent years, it is intensively expected to form patterns at the nanometer size and therefore it has been difficult to satisfy this requirement with the glass mask as explained above.

In addition, a method to form a fine pattern on a substrate by condensing and irradiating various energy beams such as a laser beam and an electron beam to a photosensitive resin coated on the substrate in order to scan such photosensitive resin is also widely known. In this pattern forming method, less restriction is applied to the pattern to be formed and the desired pattern can be formed because a glass mask on which a pattern is previously formed is not required.

FIG. 1 is a diagram for explaining a pattern forming method of the prior art using a laser beam. In the pattern forming method shown in FIG. 1, the laser beam is condensed with a condenser lens and is then radiated to the photosensitive resin. A region of the photosensitive resin irradiated with the laser beam is hardened by reaction with the laser beam. Meanwhile, a region of the photosensitive resin not irradiated with the laser beam is not hardened because it is not reacted with the laser beam.

After a desired pattern is depicted with the laser beam, the unhardened region of the photosensitive resin is removed by conducting a development process and thereby a desired fine pattern can be formed on the substrate.

The followings are several documents describing conventional pattern forming methods.

Japanese Laid-Open Patent Application (JP-A) Publication No. 2006-106277

Japanese Laid-Open Patent Application (JP-A) Publication No. 2002-160079

However, in the pattern forming method using the laser beam shown in FIG. 1, a size of pattern to be formed is almost identical to the diameter of the radiation spot of the irradiated laser beam. In the case of the pattern forming method shown in FIG. 1, the minimum pattern width is about several micrometers (μm) which is identical to a diffraction limit value of a condenser lens.

Moreover, to expose a photosensitive resin with the conventional pattern forming method, the photosensitive resin starts to be hardened from the surface region of the photosensitive resin layer on the laser beam incident side. Since a fine pattern has to be formed on the surface of the substrate, pattern formation must be conducted stably under the condition that the photosensitive resin is adhered to the surface of substrate. Therefore, the laser beam should irradiate sufficiently the photosensitive resin from its surface up to the boundary of the photosensitive resin and the surface of the substrate. However, if the photosensitive resin coated on the substrate is too thick, irradiation of laser beam becomes insufficient, and the boundary of the photosensitive resin and the substrate is likely irradiated insufficiently with the laser beam. Therefore, thickness of the photosensitive resin must be rigidly controlled.

Alternatively, forming a pattern of nanometer size is possible through exposure by an electron beam. However, the price of facilities utilizing an electron beam exposure apparatus required for nanometer pattern formation are so expensive, that this pattern forming method is cost prohibitive.

It is an object of the present invention to realize a low cost fine pattern forming method.

### SUMMARY OF THE INVENTION

In order to solve the problems explained above, the present invention is characterized by the steps of forming a photosensitive member on a substrate, condensing an ultra-short pulse laser, and irradiating a condensed ultra-short pulse laser from the side of substrate by positioning the focal point of the same pulse laser at an interface between the substrate and the photosensitive member.

Moreover, the present invention is characterized by the steps of forming a photosensitive member on a surface of a substrate, positioning a pulse laser to a region of the substrate on which patterns are to be formed and positioning the focal point thereof to an interface between the substrate and the photosensitive member, irradiating said pulse laser toward the interface from the side of the substrate opposite to the side having the photosensitive resin so as to transmit the pulse laser through the substrate, and removing selectively any of the photosensitive member reacted with the pulse laser and the photosensitive member not reacted with the pulse laser.

Moreover, the present invention is characterized by a pattern forming apparatus comprising a setting part for setting the substrate on which a photosensitive member for formation of patterns is formed, an oscillator for oscillating an ultra-short pulse laser, a condensing means for condensing the ultra-short pulse laser oscillated from the oscillator, and a controller for controlling the oscillator and relatively moving the substrate and the ultra-short pulse laser, wherein the ultra-short pulse laser is irradiated toward the interface through the substrate so that the focal point of the same pulse laser is located at the interface between the photosensitive member and the substrate.

Moreover, the present invention is characterized by a manufacturing method of a recording medium, comprising the steps of forming a photosensitive member on a substrate, forming patterns on the substrate by irradiating a condensed ultra-short pulse laser from the side of the substrate by positioning the focal point of the same pulse laser to an interface between the substrate and the photosensitive member, removing selectively any of a region of the photosensitive member reacted with irradiation of the ultra-short pulse laser and a region of the photosensitive member not reacted with irradiation of the same pulse laser, forming a metal layer on the substrate from which the photosensitive member is removed, peeling the metal layer from the substrate, and forming a pattern on a recording medium using the metal layer as a die.

In addition, the present invention is characterized by a manufacturing method of a member on which patterns are formed, comprising the steps of coating a photosensitive material on the member, irradiating a pulse laser from the side of the member to an interface between the member and the photosensitive material so as to transmit the same pulse laser through the member, and removing selectively any of a region reacted with irradiation of the pulse laser or a non-reacted region thereof.

With the structure and methods explained above according to the present invention, a finer groove pattern or the like can be formed on a substrate at comparatively low cost.

### BRIEF DESCRIPTION OF THE DRAWINGS

FIG. 1 shows a pattern forming method utilizing a laser beam of the related art.

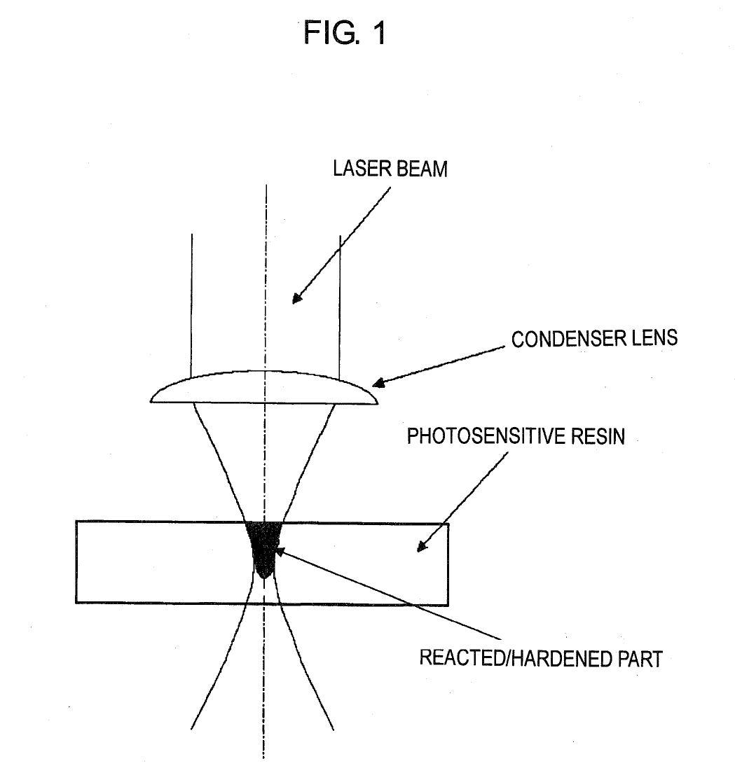

FIG. 2 shows a pattern forming method of an embodiment of the present invention.

FIG. 3 shows a method for forming a pattern to a disk substrate according to the embodiment of the present invention.

FIG. 4 shows an enlarged portion of the substrate shown in FIG. 3.

FIG. 5 shows a manufacturing method of magnetic recording medium according to the embodiment of the present invention.

FIG. 6 shows a pattern forming method according to another embodiment of the present invention.

FIG. 7 shows an enlarged portion of the pattern forming method shown in FIG. 6.

### DETAILED DESCRIPTION

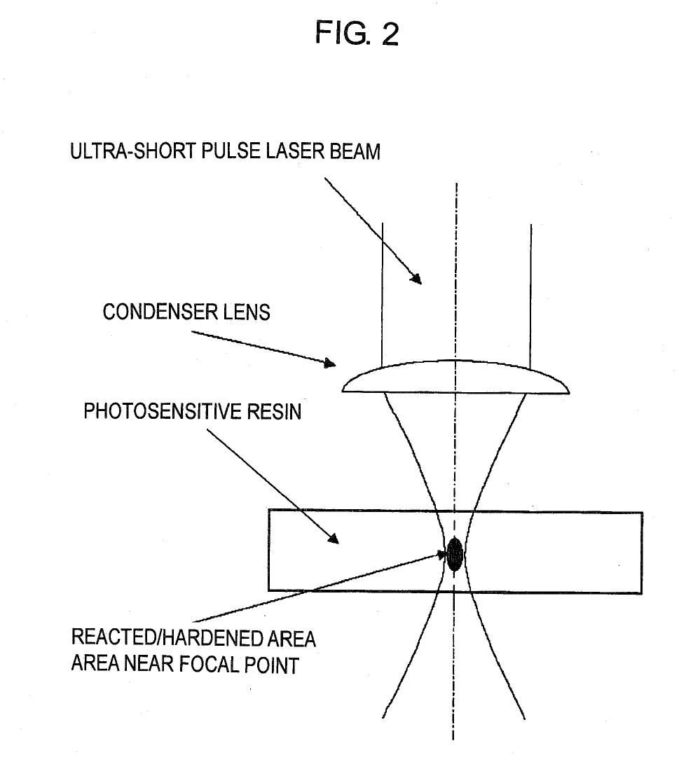

FIG. 2 is a schematic diagram showing a pattern forming method using a laser beam according to an embodiment of the present invention. In the present embodiment, an ultra-short pulse laser beam is used as a light source for exposing a photosensitive region formed on a substrate.

An ultra-short pulse laser is a laser having a very short light emitting period, as short as femtosecond to picosecond, and pulse width. Thereby a very high intensity, as high as 10¹⁰ W/cm² or more, is obtained. In the case where such an ultra-short pulse laser is used for processing a material, almost no thermal diffusion is detected from the region of the material where the ultra-short pulse laser is irradiated. Moreover, since the laser beam is absorbed only in the irradiated region of the material, no thermal influence is applied to a portion of the material peripheral to the irradiated region, and thereby high quality processes can be conducted.

Moreover, in the case where the ultra-short pulse laser is used, the laser beam is absorbed by all substances because the pulse laser is irradiated through a multiple-photon absorbing process with less dependence on the substance during the processes.

In addition, since the ultra-short pulse laser is irradiated to the substance without causing alterations to material due to an exchange of energy through plasma, it also provides an advantage that stable processing shapes can be attained.

The present embodiment utilizes the multiple-photon absorbing process among the characteristics explained above. In the multiple-photon absorbing process, the procedure can be selectively conducted only at the area near the focal point as shown in FIG. 2, as a result of condensing the ultra-short pulse laser to a fine spot by utilizing a condensing optical system such as a lens. Therefore, processes can be realized which result in an irradiated region smaller than the minimum spot diameter of the ultra-short pulse laser which is determined by the diffraction limit of the condensing optical system. It is known that the minimum processing diameter is ranged between several tens to several hundreds nanometer, when the ultra-short pulse laser beam is used. Contents related to above explanation are disclosed in the Japanese Laid-Open Patent Application, Publication No. 2006-106277.

In the present embodiment, a photosensitive resin that is transparent to a laser beam, such as a light-hardening resin, is preferably the material to be processed. Only a region of the photosensitive resin that is smaller than a spot size of the ultra-pulse laser is hardened, by setting a focal point of the ultra-short pulse laser to a portion within the photosensitive resin.

Moreover, the ultra-short pulse laser is condensed and irradiated in such a manner as to locate a focal point of the ultra-short pulse laser at an interface between the substrate and the photosensitive resin layer formed on the substrate. When an irradiation of the ultra-short pulse laser is completed, unhardened portion of the resin is removed from the substrate by conducting a cleaning process or development process. As a result, a nanometer-sized fine pattern is formed on a surface of the substrate.

A more tangible pattern forming sequence will be explained with reference to the accompanying drawings.

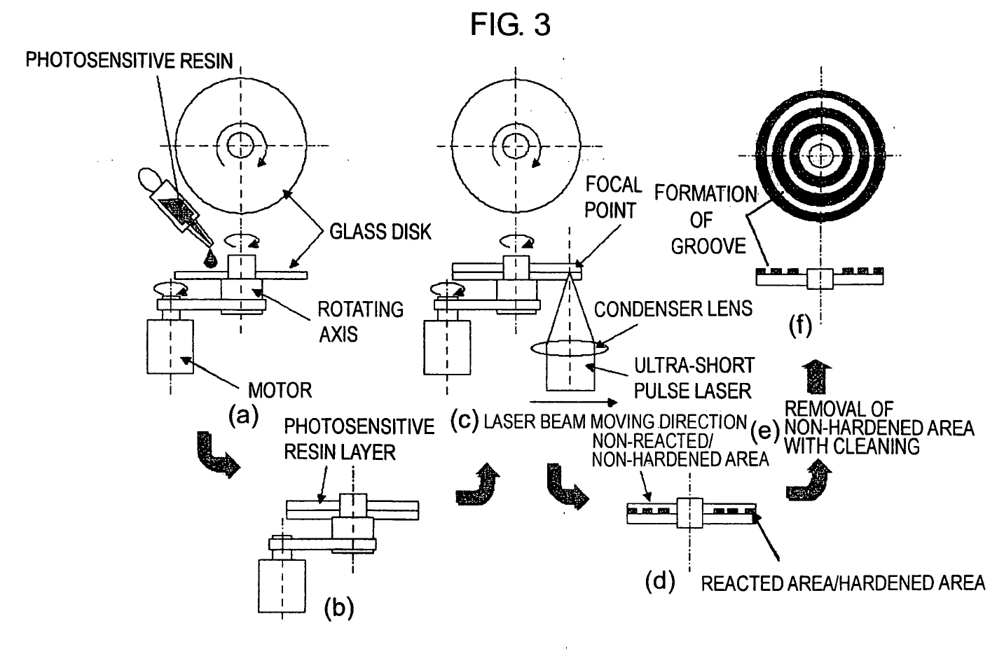

FIG. 3 is a diagram explaining the sequence of pattern formation on a disk type member according to the present embodiment. Specifically, forming concentric grooves on the disk type member. For example, this disk type member may be used as a die, or a mold, of a magnetic recording medium on which grooves are formed.

As shown in FIG. 3(a), a glass disk (substrate) on which a pattern will be formed is fixed on a rotating axis. The glass disk is processed flat to have a uniform thickness. The rotating axis is rotated in the direction indicated by the arrow marked in FIG. 3(a) with a motor connected to the rotating axis with a belt. While the glass disk is being rotated, the photosensitive resin liquid is dropped on the surface of the glass disk. A photosensitive resin layer having a uniform thickness is formed on the surface of the glass disk by rotating the glass disk (b).

Subsequently, the ultra-short pulse laser is irradiated to the photosensitive resin layer, by positioning the ultra-short pulse laser in a manner that the focal point of the ultra-short pulse laser is set at the interface between the substrate and the photosensitive resin layer, while the glass disk is rotated (c). The ultra-short pulse laser is relatively moved under the glass disk in the direction indicated by the arrow (1). The ultra-short pulse laser is irradiated to the desired location of the glass disk after positioning of the ultra-short pulse laser. Thereby, the photosensitive resin layer at the area irradiated with the ultra-short pulse laser is reacted and hardened.

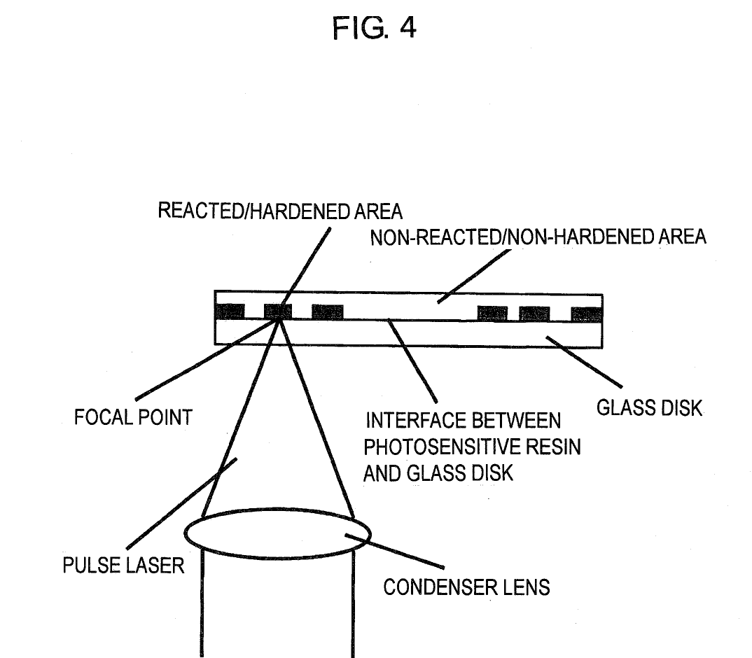

FIG. 4 is a diagram showing an enlarged part of the glass disk after irradiation with the ultra-short pulse laser. As illustrated in FIG. 4, the ultra-short pulse laser is condensed with a condenser lens and is also set to allow the focal point to hit the interface between the photosensitive resin layer and the glass disk. An area of the photosensitive resin layer irradiated with the ultra-short pulse laser is reacted with the laser beam and is thus hardened. Meanwhile, an area of the photosensitive resin layer not irradiated with the ultra-short pulse laser is left as the non-reacted, non-hardened area.

In the present invention, the ultra-short pulse laser is preferably radiated through the glass disk, in other words, from the side of the glass disk where the photosensitive resin layer is not formed. Although the photosensitive resin layer is formed in a uniform thickness, there is a high possibility that a strict thickness of the photosensitive resin layer is not even and varies within a very narrow range. Therefore, when the ultra-short pulse laser is radiated from the side of the glass disk on which the photosensitive resin layer is formed, a certain area is likely insufficiently irradiated.

Meanwhile, uniform thickness of the glass disk is attainable at an accuracy higher than that of the photosensitive resin layer. Therefore, by radiating the ultra-short pulse laser through the glass disk, the photosensitive resin layer can be exposed sufficiently, without any influence in change of the focal point of the ultra-short pulse laser due to refraction generated by non-uniformity of the thickness of the photosensitive resin layer. Thereby, a size of the hardening pattern becomes more stable.

Moreover, since the ultra-short pulse laser is radiated through the glass disk in this embodiment, the photosensitive resin layer can be exposed from the side interfacing the glass disk. As a result, the photosensitive resin layer starts to be hardened from the side contacting the glass disk. Therefore, management of the thickness of the photosensitive resin layer requires less severity than that of the pattern forming method of the prior art.

The hardened area and non-hardened area are formed on the photosensitive resin layer, as shown in FIG. 3(d) by hardening a portion of the photosensitive resin as explained above. Thereafter, a disk in which concentric grooves are formed thereon is produced as shown in FIG. 3(f), by cleaning and removing the non-hardened area of the photosensitive resin layer from the glass disk.

The concentric grooves are formed on the glass disk in FIG. 3, but a spiral groove can be formed on the glass disk by relatively moving the ultra-short pulse laser, in synchronization with rotation of the disk, wherein the glass disk has a constant velocity maintained along its radius direction.

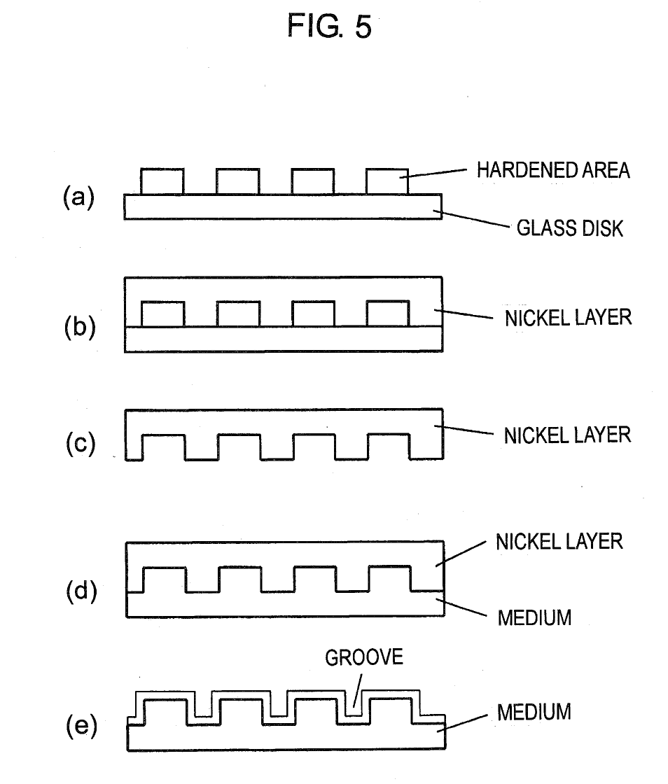

FIG. 5 is a diagram showing the sequence of producing a substrate of magnetic recording medium (magnetic recording disk) using a disk on which the grooves are formed in the sequence shown in FIG. 3 and FIG. 4. In the magnetic recording medium as shown in FIG. 5, the concentric grooves are formed on the surface of the medium. In order to form the grooves, the pattern forming method of this embodiment is utilized.

FIG. 5(a) shows a glass disk on which the grooves are formed with the process shown in FIG. 3 and FIG. 4. The hardened area formed by reaction of the photosensitive resin with the light beam is maintained on the glass disk.

Subsequently, as shown in FIG. 5(b), a nickel layer, for example, is formed on the glass disk. The nickel layer is formed by a sputtering or plating process or the like. Next, the nickel layer formed on the glass disk is peeled, or removed, from the surface of the glass disk (c). The peeled, removed nickel layer is used as a stamper.

Thereafter, grooves are formed on a substrate of the magnetic recording medium (d) by using the peeled nickel layer as a die or stamper. Then, the nickel layer is removed from the surface of the medium. In addition, the magnetic recording medium is produced by forming a magnetic layer and conducting various coating processes on the medium.

In the example explained above, matters related to the magnetic recording medium have been explained as an example of the recording medium. However, the recording medium is not limited to the magnetic recording medium. The method of producing recording medium explained with reference to FIG. 5 can easily be applied to other types of recording mediums requiring formation of patterns such as grooves on the surface of the medium.

For instance, the method of the present embodiment can also be applied to manufacture a recording medium conducting optical recording steps.

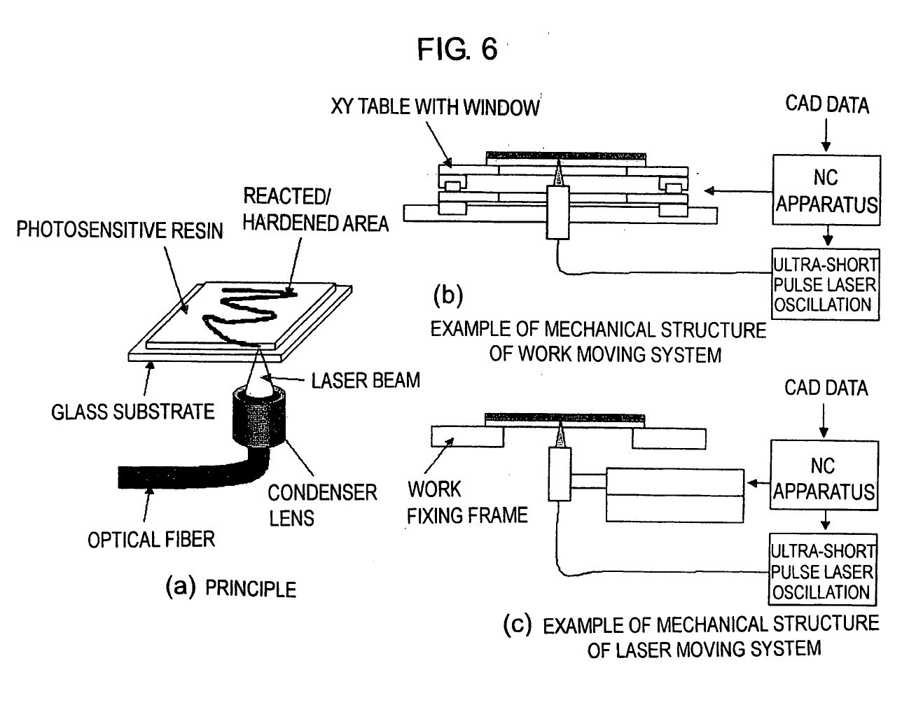

In the example explained above, grooves are formed on the disk type substrate, but the object to form grooves according to the present invention is not limited to the rotating disk type substrate. FIG. 6 is a diagram showing a sequence to form the groove on a substrate without rotating the substrate.

FIG. 6(a) is a diagram showing a principle organization of a sequence for forming grooves on a substrate. In FIG. 6(a), a photosensitive resin layer is formed on a glass substrate. The ultra-short pulse laser guided from a light source with an optical fiber is condensed with a condenser lens to locate the focal point thereof at the interface between the glass substrate and the photosensitive resin layer, and the laser is then emitted. Thereafter, the photosensitive resin can be hardened in the desired pattern by relatively moving the ultra-short pulse laser and/or the glass substrate.

FIG. 6(b) is a diagram showing a structure of an apparatus for moving a work such as a glass substrate. In the example of FIG. 6(b), the glass substrate is placed on an XY table provided with a window. CAD data, including information corresponding to the pattern to be formed on the glass substrate, is supplied to an NC apparatus from a storage device. The NC apparatus moves the XY table in accordance with the pattern shown in the CAD data.

Meanwhile, the NC apparatus turns on a laser oscillator, in accordance with movement of the XY table, when a laser emitting port is located at the position of the glass substrate to form the pattern thereon, the ultra-short pulse laser radiates toward the desired part on the glass substrate. Moreover, when a part of the glass substrate not required to form the pattern is located at the laser emitting port, the NC apparatus turns off the laser oscillator. With the structure explained above, a desired pattern can be formed on the glass substrate.

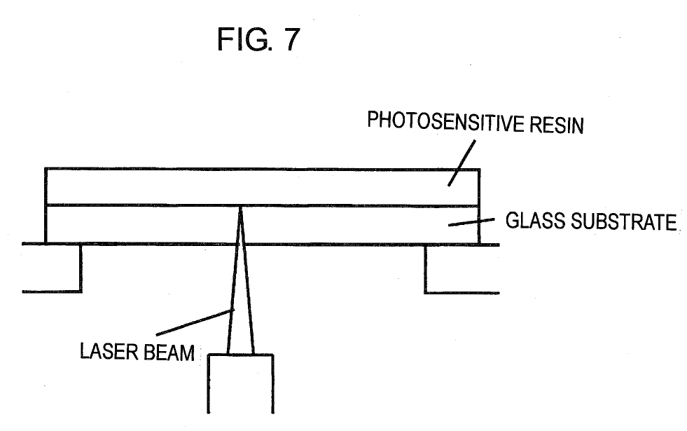

Referring to FIG. 7, the ultra-short pulse laser is radiated to locate the focal point at the interface between the glass substrate and photosensitive resin as is explained in the embodiment shown in FIG. 3.

FIG. 6(c) is a diagram showing an example of a structure of the apparatus for moving the laser beam in place of a work. In the example of FIG. 6(c), the laser emitting port with a condenser lens is mounted to a movement mechanism which can be move in the plane direction. On the other hand, the work or glass substrate is fixed to a work fixing frame. Like the example of FIG. 6(b), the CAD data corresponding to the pattern to be formed on the glass substrate, is supplied to the NC apparatus, and the NC data controls the laser emitting port to move in accordance with the CAD data. In accordance with this movement of the laser emitting port, the NC apparatus turns on the laser oscillator when the laser emitting port is located at the position of the glass substrate where the pattern is to be formed, but turns off the laser oscillator in the other locations.

An example of forming the groove on the substrate using the light hardening resin has been explained in the above example. Apart from the above-explained example, formation of a fine pattern using the ultra-short pulse laser is also possible by using a material, such as photoresist used for manufacturing semiconductor devices, which is hardened by conducting a baking process after coated on the substrate, or a solid-state photosensitive material like a dry film.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A pattern forming method for forming a pattern on a substrate, comprising:
forming a photosensitive member on a surface of the substrate;
condensing an ultra-short pulse laser; and
irradiating a condensed ultra-short pulse laser onto the substrate by positioning the focal point of the said pulse laser at an interface between the substrate and the photosensitive member.

2. A pattern forming method for forming a groove type pattern on a substrate, comprising the steps of:
forming a photosensitive member on a surface of the substrate;
positioning a pulse laser to a region of the substrate on which patterns are formed by positioning the focal point of said pulse laser at an interface between the substrate and the photosensitive member;
irradiating the pulse laser toward the interface by transmitting the pulse laser through the substrate; and
removing selectively any of the photosensitive member reacted with the pulse laser and the photosensitive member not reacted with the pulse laser.

3. A pattern forming apparatus for forming a pattern on a substrate, comprising:
a setting part for setting the substrate on which a photosensitive member for formation of patterns is allocated;
an oscillator for oscillating an ultra-short pulse laser;
a condensing means for condensing the ultra-short pulse laser oscillated from the oscillator; and
a controller for controlling the oscillator and relatively moving the substrate and the ultra-short pulse laser;
wherein the ultra-short pulse laser is irradiated toward the substrate so that the focal point of the same pulse laser is located at an interface between the photosensitive member and the substrate.

4. The pattern forming apparatus according to claim 3, further comprising a setting part moving member for moving the setting part on which the substrate is placed, wherein the controller also controls the setting part moving member.

5. The pattern forming apparatus according to claim 3, further comprising a laser moving member for moving the ultra-short pulse laser wherein the controller also controls the laser moving member.

6. The pattern forming apparatus according to claim 5, wherein the laser moving member is provided with the condensing means wherein the controller controls the laser moving member including the condensing means.

7. A manufacturing method of a recording medium, comprising:
forming a photosensitive member on a substrate;
forming patterns on the substrate by irradiating a condensed ultra-short pulse laser onto a side of the substrate by positioning the focal point of the pulse laser to an interface between the substrate and the photosensitive member;
removing selectively any of a region of the photosensitive member reacted with irradiation of the ultra-short pulse laser and a region of the photosensitive member not reacted with irradiation of the same pulse laser;
forming a metal layer on the substrate from which the photosensitive member is removed;
peeling the metal layer from the substrate; and
forming a pattern on a recording medium using the metal layer as a die.

8. The manufacturing method of recording medium according to claim 7, wherein the recording medium is a magnetic recording medium and further comprises;
a step of forming a magnetic recording layer on the recording medium.

9. A method of manufacturing a patterned member on which a pattern is formed, comprising:
coating a photosensitive member on the member;
irradiating a pulse laser to an interface between the member and the photosensitive member through the member; and
removing selectively any of the region of photosensitive member reacted with irradiation of said pulse laser and the region of photosensitive member not-reacted with the same pulse laser.

10. The method of manufacturing a patterned member according to claim 9, wherein the pulse laser radiating step comprises the steps of
moving relatively the member and the pulse laser in accordance with the desired pattern to be formed; and
radiating the pulse laser to the interface between the member and the photosensitive member when the pulse laser has moved to the location corresponding to the pattern.

11. A pattern forming method for forming a pattern on a substrate, comprising:
forming a photosensitive layer on a surface of the substrate;
positioning an ultra-short pulse laser source, on an opposite side of the substrate at which the photosensitive layer is not formed, so as to focus the ultra-short pulse laser at a boundary of the substrate and the photosensitive layer;
emitting the ultra-short pulse laser source; and
selectively removing a portion of the photosensitive layer among the portion in which is exposed by the ultra-short pulse laser and the other portion.

12. The pattern forming method according to claim 11, further comprising:
moving the ultra-short pulse laser source relative to the substrate; and
selectively emitting the ultra-short pulse laser during the moving to draw a desired pattern on the substrate.

13. The pattern forming method according to claim 11, wherein the substrate is formed of a transparent material through which the ultra-short pulse laser used to expose the photosensitive layer is transmitted.

14. A pattern forming apparatus comprising:
a stage which is capable of holding a substrate having a photosensitive layer formed on a surface thereof;
a laser source which is capable of emitting ultra-short pulse laser, an emitting port of the ultra-short pulse laser is position so as to face an opposite surface of the substrate at which the photosensitive layer is not formed; and
a controller which is capable of controlling on and off state of the laser source, and of controlling a movement of the stage.

15. The pattern forming apparatus according to claim 14, further comprising:
a storage unit which is capable of storing data to control the laser source and the stage to form a desired pattern onto the substrate;
wherein the controller controls the laser source and the stage according to the data stored in the storage unit.

16. The pattern forming method according to claim 12, wherein the substrate is formed of a transparent material through which the ultra-short pulse laser used to expose the photosensitive layer is transmitted.
